(19) United States
(12) Patent Application Publication
(10) Pub. No.: US 2011/0181561 A1
(43) Pub. Date: Jul. 28, 2011

(54) Active Matrix OLED Displays and Driver Therefor

(75) Inventor: Euan C. Smith, Cambridgeshire (GB)

(73) Assignee: CAMBRIDGE DISPLAY TECHNOLOGY LIMITED

(21) Appl. No.: 13/056,119

(22) PCT Filed: Jul. 30, 2009
(86) PCT No.: PCT/GB09/01879

§ 371 Date: Apr. 11, 2011

(30) Foreign Application Priority Data
Aug. 1, 2008 (GB) 0814021.2

(51) Int. Cl. G09G 3/30; G06F 3/038

(52) U.S. Cl. 345/204; 345/76

(57) ABSTRACT

A display has a plurality of organic light emitting diode (OLED) pixels each with an associated pixel driver circuit, a plurality of select lines and a plurality of data lines. Each pixel driver circuit is coupled to a select line and to a data line. The pixel driver circuit includes a drive transistor configured to drive an OLED and a select transistor having a first terminal coupled to a select line and a second terminal coupled to a data line, wherein one of the terminals of said select transistor comprises a gate connection of said select transistor and wherein the other terminal comprises one of a drain and a source connection of said select transistor, and wherein said select transistor comprises source, drain and gate regions, wherein said gate region at least partially overlaps said source and drain regions, and wherein an area of said overlap of said gate region with one of said source region and said drain region is greater than an area of said overlap with the other region so that a capacitance between said gate connection and one of said drain and source connections is less than a capacitance between said gate connection and the other connection.

### FIELD OF THE INVENTION

This invention relates to pixel driver circuits for active matrix optoelectronic devices, in particular OLED (organic light emitting diodes) displays, and the associated displays.

### BACKGROUND TO THE INVENTION

Embodiments of the invention will be described while particularly useful in active matrix OLED displays although applications and embodiments of the invention are not limited to such displays and may be employed with other types of active matrix display and also, in embodiments, in active matrix sensor arrays.

Organic light emitting diodes, which here include organometallic LEDs, may be fabricated using materials including polymers, small molecules and dendrimers, in a range of colours which depend upon the materials employed. Examples of polymer-based organic LEDs are described in WO 90/13148, WO 95/06400 and WO 99/48160; examples of dendrimer-based materials are described in WO 99/21935 and WO 02/067343; and examples of so called small molecule based devices are described in U.S. Pat. No. 4,539,507. A typical OLED device comprises two layers of organic material, one of which is a layer of light emitting material such as a light emitting polymer (LEP), oligomer or a light emitting low molecular weight material, and the other of which is a layer of a hole transporting material such as a polythiophene derivative or a polyaniline derivative.

Organic LEDs may be deposited on a substrate in a matrix of pixels to form a single or multi-colour pixellated display. A multicoloured display may be constructed using groups of red, green, and blue emitting sub-pixels. So-called active matrix displays have a memory element, typically a storage capacitor, and a transistor, associated with each pixel (whereas passive matrix displays have no such memory element and instead are repetitively scanned to give the impression of a steady image). Examples of polymer and small-molecule active matrix display drivers can be found in WO 99/42983 and EP 0,717,446A respectively.

It is common to provide a current-programmed drive to an OLED because the brightness of an OLED is determined by the current flowing through the device, this determining the number of photons it generates, whereas in a simple voltage-programmed configuration it can be difficult to predict how bright a pixel will appear when driven.

An example of a voltage driven pixel driver circuit is described in US 2006/0244696. This employs a driving transistor with a curved or serpentine channel and describes a colour display in which blue pixels are larger than green pixels so that pixel rows have two opposite boundaries, a curved boundary and a straight boundary. Further background prior art can be found in US 2005/0116295, which describes an annular segment MOSFET structure and illustrates a circular n-channel MOSFET. A transistor with a curved gate layer is also described in U.S. Pat. No. 6,599,781.

Background prior art relating to current programmed active matrix pixel driver circuits can be found in “Solution for Large-Area Full-Color OLED Television—Light Emitting Polymer and a-Si TFT Technologies”, T. Shirasaki, T. Ozaki, T. Toyama, M. Takei, M. Kumagai, K. Sato, S. Shimoda, T. Tano, K. Yamamoto, K. Morimoto, J. Ogura and R. Hattori of Casio Computer Co Ltd and Kyushu University, Invited paper AMD3/OLED5—1, 11^{th} International Display Workshops, 8-10 Dec. 2004, IDW '04 Conference Proceedings pp275-278.

FIGS. 1a and 1b, which are taken from the IDW '04 paper, show an example current programmed active matrix pixel circuit and a corresponding timing diagram. In operation, in a first stage the data line is briefly grounded to discharge Cs and the junction capacitance of the OLED (Vselect, Vreset high; Vsource low). Then a data sink Idata is applied so that a corresponding current flows through T3 and Cs stores the gate voltage required for this current (Vsource is low so that no current flows through the OLED, and T1 is on so T3 is diode connected). Finally the select line is de-asserted and Vsource is taken high so that the programmed current (as determined by the gate voltage stored on Cs) flows through the OLED (I_{OLED}).

Referring again to FIG. 1a, this shows a single pixel circuit but it will be appreciated that in a typical OLED display (colour or monochrome) comprising many rows and columns of pixels there will be a plurality of such pixel circuits connected to each data line (as illustrated, in a column) and to each select line (as illustrated, in a row). A typical programming current for an OLED is of order 1-10 μA, for example 2-5 μA, and this is applied to one end of the data line but is used to charge the pixel storage capacitor C. Thus the resistance of the data line and of the switch/select transistor T2 is significant, as is the total capacitance on the data line which is in part determined by the gate-to-drain/source capacitance of each select transistor connected to the data line. Broadly speaking the RC time constant is the product of the number of rows of the display, the resistance of the switch/select transistor when this is on and the input capacitance (gate-to-drain/source) of a said switch/select transistor. Voltage driven pixel circuits, which also have a switch/stroke select transistor, exhibit similar problems.

It is desirable to reduce the programming time of a pixel and there are a number of convention approaches to this problem. One approach involves reducing the resistance of the data line by employing a copper connection. Another involves driving a larger voltage change on the programming (data) line to drive the current. It might be imagined that the width-to-length ratio of the switch/select transistor could be increased to decrease the resistance of this transistor and hence decrease the programming time, but this has the undesired side effect of increasing the input capacitance of this transistor which tends to work against the desired reduction in programming time. A still further approach to reducing programming time is to employ a self-aligned process for fabricating the thin film transistors of the pixel driver circuit since by employing a self-aligned gate overlap between the source/drain regions and the gate region may be effectively eliminated, thus reducing the internal capacitance of the field effect transistor (FET).

Improved techniques to reduce the programming time of an active matrix pixel are therefore desirable.

### SUMMARY OF INVENTION

According to a first aspect of the invention there is therefore provided an active matrix organic light emitting diode (OLED) display, the display having a plurality of OLED pixels each with an associated pixel driver circuit, said display having a plurality of select lines and a plurality of data lines to select a said OLED pixel and to write data for display to a selected said OLED pixel, wherein each said pixel driver circuit is coupled to a said select line and to a said data line, wherein said pixel driver circuit includes a select transistor having a first terminal coupled to a said select line and a second terminal coupled to a said data line, wherein one of said first and second terminals of said select transistor comprises a gate connection of said select transistor and wherein the other of said first and second terminals of said select transistor comprises one of a drain and a source connection of said select transistor, and wherein said select transistor comprises a transistor with source, drain and gate regions, wherein said gate region at least partially overlaps said source and drain regions, and wherein an area of said overlap of said gate region with one of said source region and said drain region is greater than an area of said overlap with the other of said source region and said drain region.

The inventors have recognised that fabricating an asymmetric select transistor, in particular with a curved gate region, the capacitance on one side of the select transistor may be decreased at the expense of increasing the capacitance on the other side of the transistor. However in the context of an active matrix pixel circuit this provides an overall performance gain since it is the input capacitance which primarily determines the programming time and thus by reducing the input capacitance of the switch/select transistor, even though the capacitance on the other side of this transistor may be increased, overall the programming time may be reduced. In embodiments the second terminal, which is coupled to the data line, comprises the source/drain region with the smaller area of overlap with the gate region.

The source region and drain region may have a variety of different shapes provided that one of the regions partially curves around or encompasses the other. For one region to curve around the other it need not have a smooth curve but instead, for example, a pair of arms or projections. Likewise although shapes with smooth curves may be preferable for ease of fabrication and/or electric field reduction, they are not essential. In embodiments the channel of the select transistor is curved in one direction only - that is it does not have a serpentine shape. In embodiments a curved, arcuate or horseshoe shape is preferable since this is relatively efficient in terms of the device geometry and area occupied.

In some preferred embodiments the capacitance ratio between the gate region and the different respective source/drain regions is at least 1:1.5, preferably at least 1:2. For example the smaller area of overlap may have an area in the range 20 μm² to 150 μm². In embodiments the channel has a width of at least 1 μm or 2 μm; preferably a maximum lateral dimension of the larger source/drain region is at least 2 μm, 4 μm or 6 μm greater than a maximum lateral dimension of the smaller source/drain region.

In some preferred embodiments the select transistor is a bottom-gate device and the display is a top-emitting display. Generally the pixel driver circuit includes a data storage capacitor coupled either directly or indirectly to a third terminal of the select transistor (in embodiments the drain/source region not connected to the data line). The pixel driver circuit will generally also include a drive transistor having a control input coupled to the data storage capacitor and an output for driving an OLED; typically this has one source/drain region coupled to a voltage source and the other coupled to an OLED. Embodiments of the pixel driver circuit may also include one or more further transistors, depending upon the implementation of the circuit. The pixel driver circuit may be a voltage controlled circuit but in preferred embodiments a current-controlled circuit is employed.

In embodiments of the pixel driver circuit with at least one further transistor (apart from the select transistor and the drive transistor) the ability to change a ratio of capacitance between the gate terminal and the two drain/source terminals can provide an additional degree of design freedom. Thus typically in programming a pixel circuit there are voltage swings within the circuit and the internal capacitances of the transistors within the circuit may be adjusted to control these—in effect a designer has some ability to choose values for the internal or “stray” capacitances within the pixel circuit.

Thus in a further aspect the invention provides a method of designing an active matrix pixel circuit in which a ratio of one or more internal gate-source/drain: gate-drain/source capacitances of transistors of the circuit are adjusted. There is also provided an active matrix pixel circuit designed using this method, and a display incorporating a plurality of such pixel circuits.

For example in embodiments of, say, a current-programmed pixel driver circuit of the type illustrated in FIG. 1a the internal capacitance ratios of the switch/select transistor and of the programming transistor (T1) may be adjusted to reduce the effects of the voltage swing on the select line (which may be, for example, up to 20 volts) partially cancelling the voltage swing on the voltage source line (which may be, for example, 5-10 volts) during programming.

In a related aspect the invention provides a pixel circuit for an active matrix display, the pixel circuit having a select line to select the pixel, and a data line for reading or writing pixel data from or to the pixel, wherein the pixel driver circuit further comprises a pixel select transistor having two channel connections and a gate connection, and wherein said gate connection is coupled to one of said data line and said select line, wherein a first of said channel connections is coupled to the other of said data line and said select line, and wherein an internal capacitance of said pixel select transistor between said gate connection and said first of said channel connections is less than internal capacitance of said pixel select transistor between said gate connection and a second of said channel connections.

Preferably the smaller of the two internal gate-source/drain capacitances is less than ⅔, more preferably less than one half of the larger. As described above, in embodiments the second channel region at least partially wraps around the first channel region.

The pixel circuit may comprise a sensor circuit additionally or alternatively to a pixel driver circuit. However in embodiments the circuit comprises a pixel driver circuit for an OLED, the pixel data comprising pixel luminance data for the OLED. In preferred embodiments the pixel driver circuit is a current-controlled circuit, for example as described above.

In a further related aspect the invention provides a pixel circuit for an active matrix display, said pixel circuit including at least one field effect transistor (FET) with a curved gate region such that a gate-source capacitance of said FET is different to a gate-drain capacitance of said FET.

In embodiments the FET is asymmetric about a line along the centre of the channel between the source and drain region and, in particular, is curved in one direction only (unlike a serpentine channel device).

The invention also provides an active matrix display, in particular an electroluminescent display, more particularly an OLED display incorporating a pixel circuit as described above.

### BRIEF DESCRIPTION OF THE DRAWINGS

These and other aspects of the invention will now be further described, by way of example only, with reference to the accompanying figures in which:

FIGS. 1a to 1g show examples of pixel circuits according to the prior art and a corresponding timing diagram, and further examples of active matrix pixel driver circuits;

FIGS. 2a to 2d show, respectively, a schematic illustration of a conventional thin film transistor, a schematic illustration of a curved channel thin film transistor, a schematic diagram of an active matrix OLED display incorporating a plurality of pixel driver circuits according to an embodiment of the invention, and examples of alternative channel shapes which may be employed with embodiments of the invention;

FIGS. 3a and 3b, respectively, a vertical cross-section through an embodiment of the device of FIG. 2b, and steps in the fabrication of the device of FIG. 3a;

FIG. 4 shows the circuit of FIG. 1a illustrating parasitic/internal capacitances; and

FIG. 5 shows an example of an active matrix sensor circuit incorporating a curved gate transistor.

### DETAILED DESCRIPTION OF PREFERRED EMBODIMENTS

We will describe the use of an asymmetric thin film transistor (TFT) structure for the reduction of data line capacitance. The use of a curved, for example semi-circular, channel transistor enables the preferential reduction of the capacitance between the gate and one of the source/drain terminals of the transistor. Incorporating such a curved channel device into the pixel circuit of an active matrix OLED display enables improved pixel circuits to be designed. For example in the case of a select TFT connected to a programming data line on a TFT display backplane the programming time for an OLED pixel may be reduced. In embodiments the curved channel reduces the gate-contact capacitance on the inner radius whilst allowing the gate-contact capacitance on the outer radius to increase, without substantially changing the DC device performance.

### Active Matrix Pixel Circuits

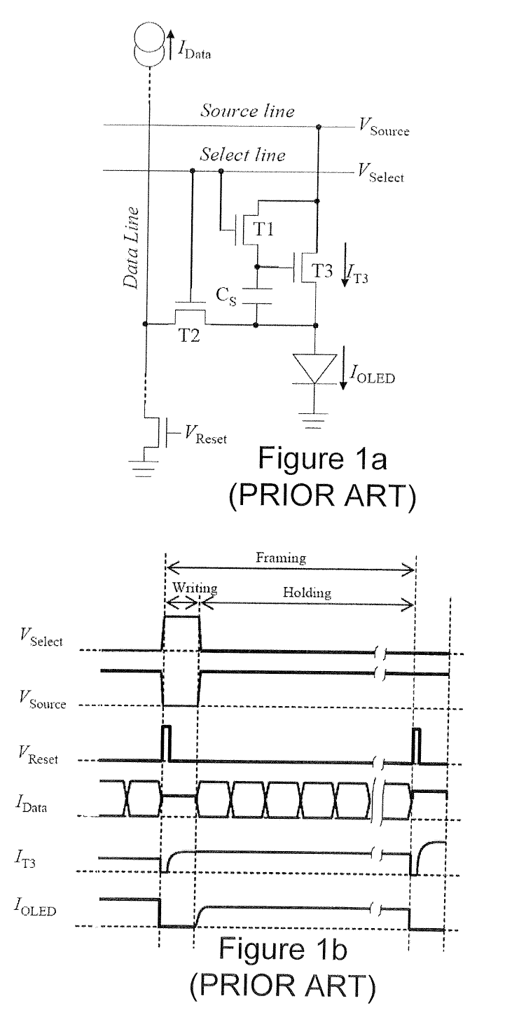

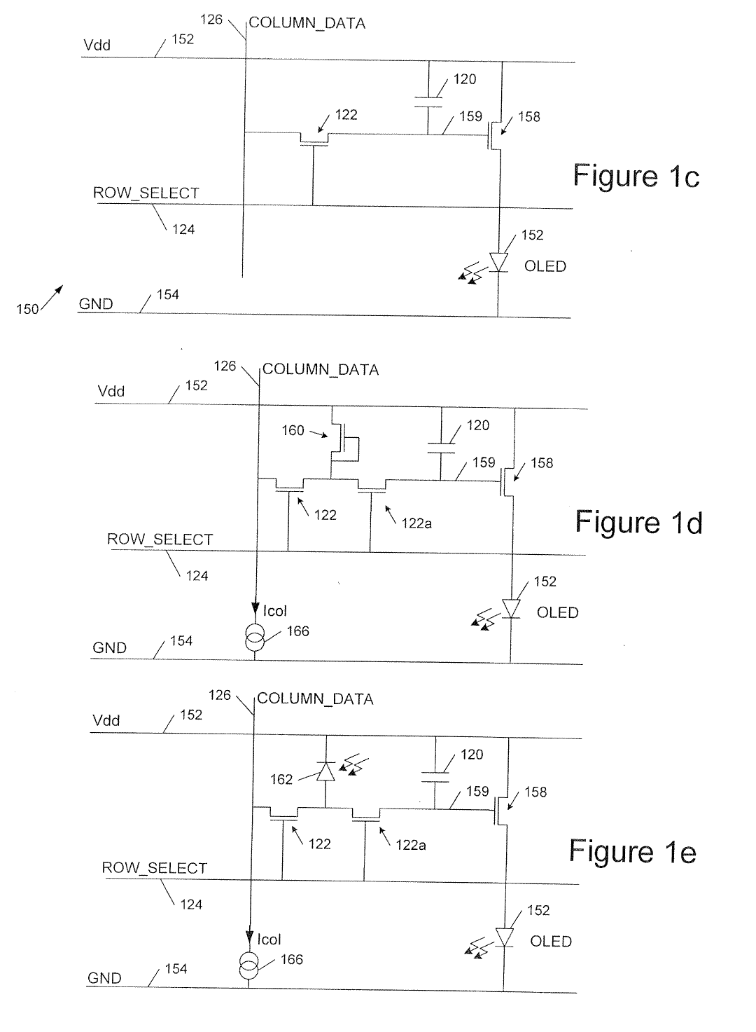

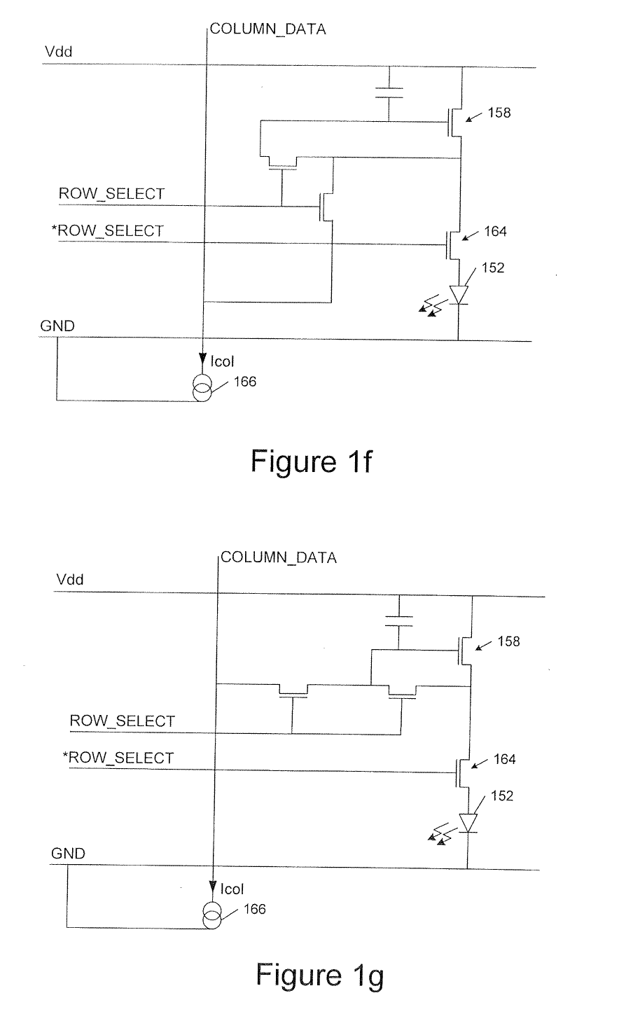

FIG. 1c shows an example of a voltage programmed OLED active matrix pixel circuit 150. A circuit 150 is provided for each pixel of the display and Vdd 152, Ground 154, row select 124 and column data 126 busbars are provided interconnecting the pixels. Thus each pixel has a power and ground connection and each row of pixels has a common row select line 124 and each column of pixels has a common data line 126.

Each pixel has an OLED 152 connected in series with a driver transistor 158 between ground and power lines 152 and 154. A gate connection 159 of driver transistor 158 is coupled to a storage capacitor 120 and a control transistor 122 couples gate 159 to column data line 126 under control of row select line 124. Transistor 122 is a thin film field effect transistor (TFT) switch which connects column data line 126 to gate 159 and capacitor 120 when row select line 124 is activated. Thus when switch 122 is on a voltage on column data line 126 can be stored on a capacitor 120. This voltage is retained on the capacitor for at least the frame refresh period because of the relatively high impedances of the gate connection to driver transistor 158 and of switch transistor 122 in its “off” state.

Driver transistor 158 is typically a TFT and passes a (drain-source) current which is dependent upon the transistor's gate voltage less a threshold voltage. Thus the voltage at gate node 159 controls the current through OLED 152 and hence the brightness of the OLED.

The voltage-programmed circuit of FIG. 1c suffers from a number of drawbacks, in particular because the OLED emission depends non-linearly on the applied voltage, and current control is preferable since the light output from an OLED is proportional to the current it passes. FIG. 1d (in which like elements to those of FIG. 1c are indicated by like reference numerals) illustrates a variant of the circuit of FIG. 1c which employs current control. More particularly a current on the (column) data line, set by current generator 166, “programs” the current through thin film transistor (TFT) 160, which in turn sets the current through OLED 152, since when transistor 122a is on (matched) transistors 160 and 158 form a current mirror. FIG. 1e illustrates a further variant, in which TFT 160 is replaced by a photodiode 162, so that the current in the data line (when the pixel driver circuit is selected) programs a light output from the OLED by setting a current through the photodiode.

FIG. 1f, which is taken from our application WO03/038790, shows a further example of a current-programmed pixel driver circuit. In this circuit the current through an OLED 152 is set by setting a drain source current for OLED driver transistor 158 using a current generator 166, for example a reference current sink, and memorising the driver transistor gate voltage required for this drain-source current. Thus the brightness of OLED 152 is determined by the current, I_{col}, flowing into reference current sink 166, which is preferably adjustable and set as desired for the pixel being addressed. In addition, a further switching transistor 164 is connected between drive transistor 158 and OLED 152 to prevent OLED illumination during the programming phase. In general one current sink 166 is provided for each column data line. FIG. 1g shows a variant of the circuit of FIG. 1f.

### Curved Channel Devices.

An issue with any TFT device is the capacitance caused by overlap between the contacts and the gate. This can have a significant impact in terms of circuit response time and leakage, particularly where there are a large number of devices in parallel. However where the gate and source/drain contacts are patterned separately there should be some degree of overlap to avoid a gap which, in introducing a much increased contact resistance, would have a much worse effect on conduction.

A particular case where this is a problem is with the data or programming line on a display backplane. The data line is the connection through which the pixel circuits are programmed. A gate line for a particular pixel row will close a switch transistor connecting the data line to the pixel circuit. There will be one of these switches per pixel row. Each of the switches will have some input capacitance which, while small for an individual device, becomes a problem as the row count increases, particularly with the increasing demand for ever higher resolution displays.

Depending upon the fabrication process some overlap between the gate metal and the drain/source metal may be unavoidable, for example because of alignment rules and the need to provide some degree of tolerance for misalignment. Embodiments of the invention therefore use an asymmetric device design with a curved gate region which will preferentially substantially reduce the capacitance on the data line side of each (select) transistor.

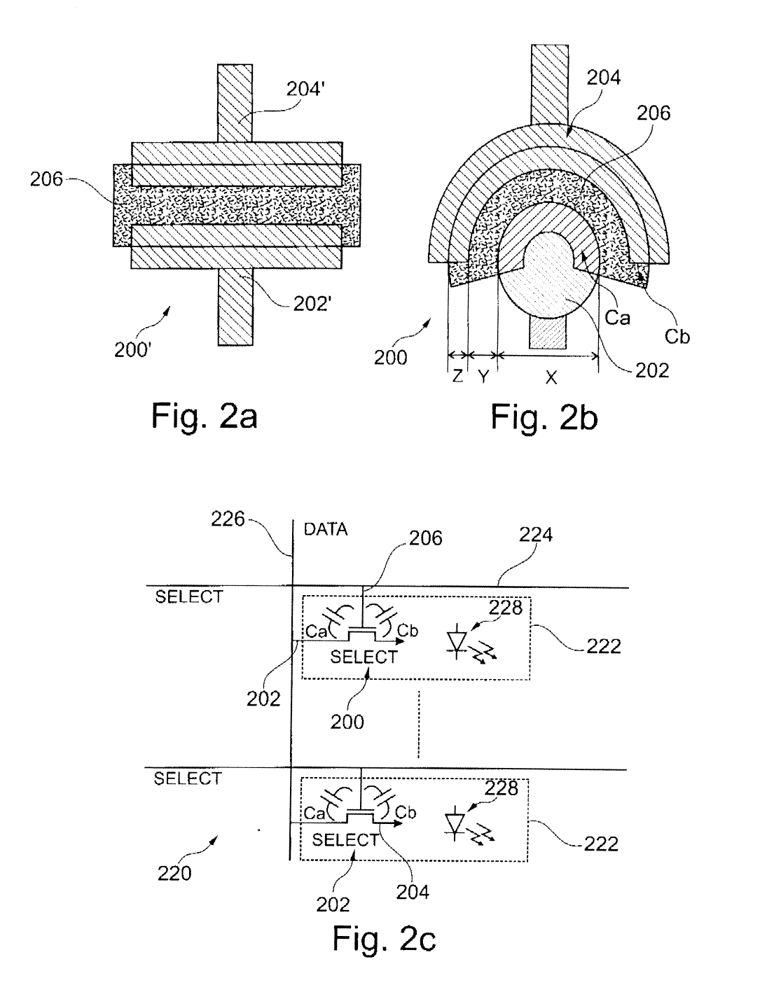

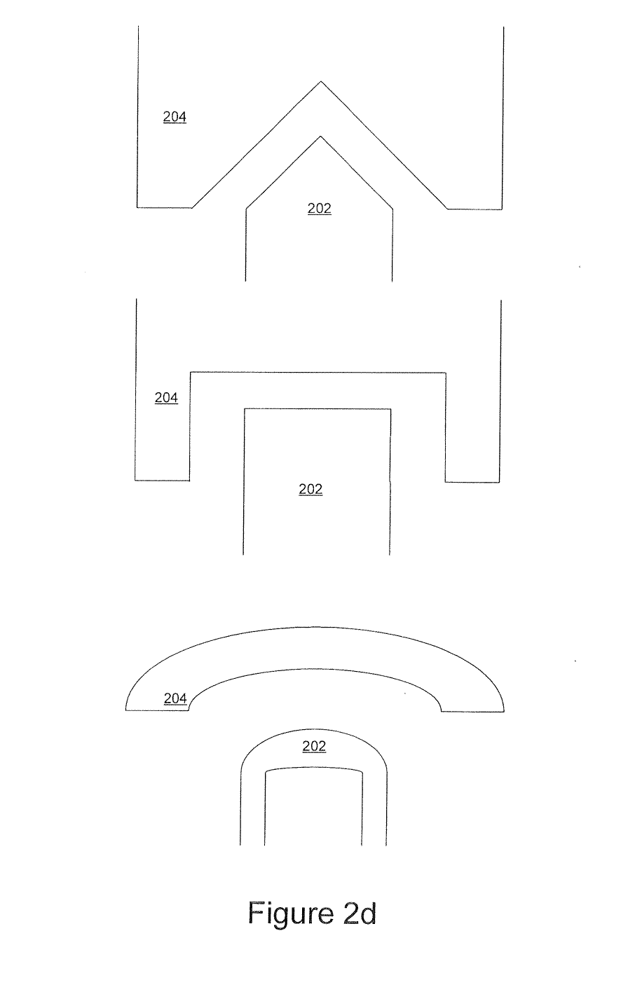

Referring to FIGS. 2a and 2b, these show schematic diagrams of a conventional device (FIG. 2a) and of a curved channel thin film transistor 200 (FIG. 2b) each with the same nominal gate width. In the device of FIG. 2b the transistor comprises a first drain/source metal region 202, a second drain/source metal region 204 and an overlying gate region 206 which, as can be seen, partially overlaps the first and second drain/source regions. (In this specification references to an “overlying” gate region do not necessarily imply that the gate is above the source/drain regions; preferred embodiments of the transistor comprise bottom gate devices). In FIG. 2a like elements to those of FIG. 2b are indicated by like reference numerals. The overlap of gate 206 with drain/source region 202 gives rise to a first internal capacitance Ca; the overlap of the gate with drain/source region 204 gives rise to a second, larger internal capacitance Cb. By inspection it can be seen that in the case of the device of FIG. 2b as compared with that of FIG. 2a, although the overlap distance is the same the area overlapped is very much reduced for the curved channel device; that is Ca is much less than Cb.

In a typical device the alignment tolerance may be of order +/−4 μm, distance x may be of order 5-10 μm, distance y of order 4 μm and distance z of order 4 μm. This gives a ratio of Cb:Ca of approximately 1.5:1 (the ratio of the areas).

Referring now to FIG. 2c, this shows a schematic circuit diagram of an active matrix OLED display 220 incorporating a plurality of pixel driver circuits 222 each including a select transistor 200 of the type shown in FIG. 2b. The gate connection of the select transistor is coupled to a select line 224 and the source/drain connection 202 with the smaller internal capacitance is connected to data line 226. In the illustrated example there is a plurality of column data lines (only one shown) and a plurality of row select lines; each pixel circuit 222 is coupled to at least one data line 226 and to at least one select line 224. The skilled person will appreciate that pixel circuit 222 may comprise any of the previously described pixel driver circuits to drive an associated OLED 228, or any of a range of other pixel drive circuits may be employed, further examples of which will be well known to those skilled in the art. Additionally or alternatively the select transistor 200 may comprise part of a pixel sensor circuit, an illustrative example of which is given later.

Referring to FIG. 2c it can be seen that by reducing capacitance Ca the overall data line capacitance can be reduced and hence the programming (or readout) time of a pixel can also be reduced.

In a physical layout of the pixel circuit it may be desirable to use the unoccupied “wings” to either side of source/drain metal region 204 for the pixel data storage capacitor (capacitor Cs in FIG. 1a). Thus, more generally, in a physical layout of pixel circuit 222 one or more regions of a rectangle which just encloses transistor 200 (in the lateral plane) may be occupied by at least part of a pixel data storage capacitor of the pixel circuit.

FIG. 2d shows some examples of alternative, albeit less preferred curved channel shapes. As can be seen from the lower figure, it is not essential that region 204 has arms or projections which encompass region 202.

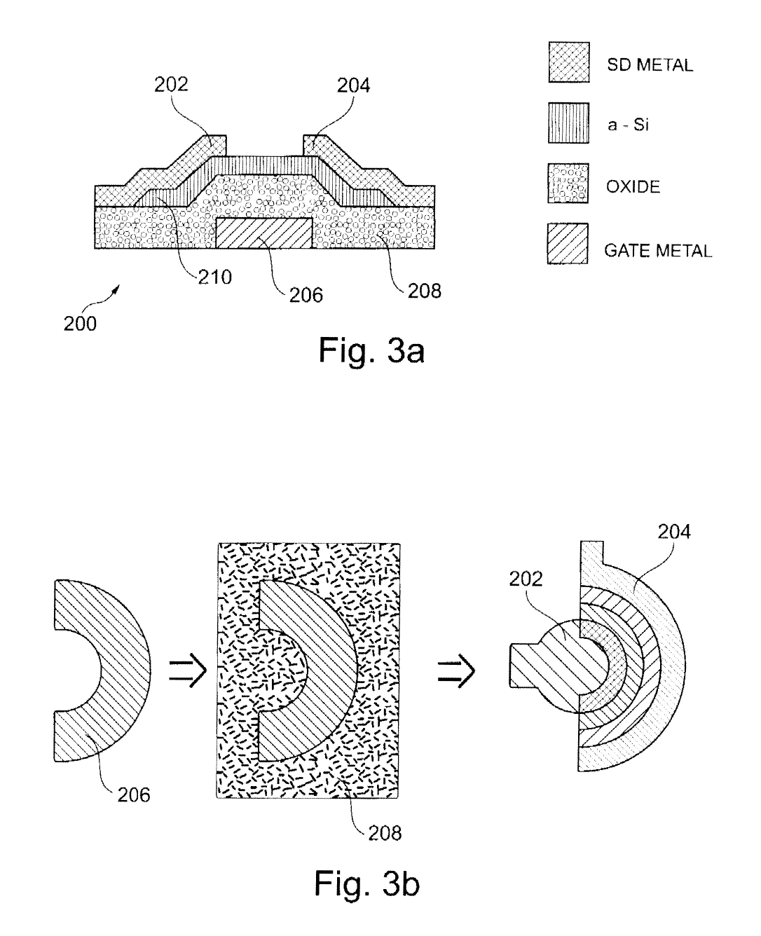

Referring now to FIG. 3a, this shows a vertical cross-section view through the transistor 200 of FIG. 2b (in which the substrate, and device connections, have been omitted for clarity). The device comprises a gate connection 206 fabricated from any suitable gate metal over which lies an oxide layer 208 followed by, in embodiments, a layer 210 of amorphous silicon, followed by a source/drain metal layer 202, 204. FIG. 3b shows steps in the fabrication of the device comprising first deposition and patterning of the gate metal layer, then deposition of an oxide layer, then deposition and patterning of an amorphous silicon and source/drain metal to provide source and drain contacts for the device.

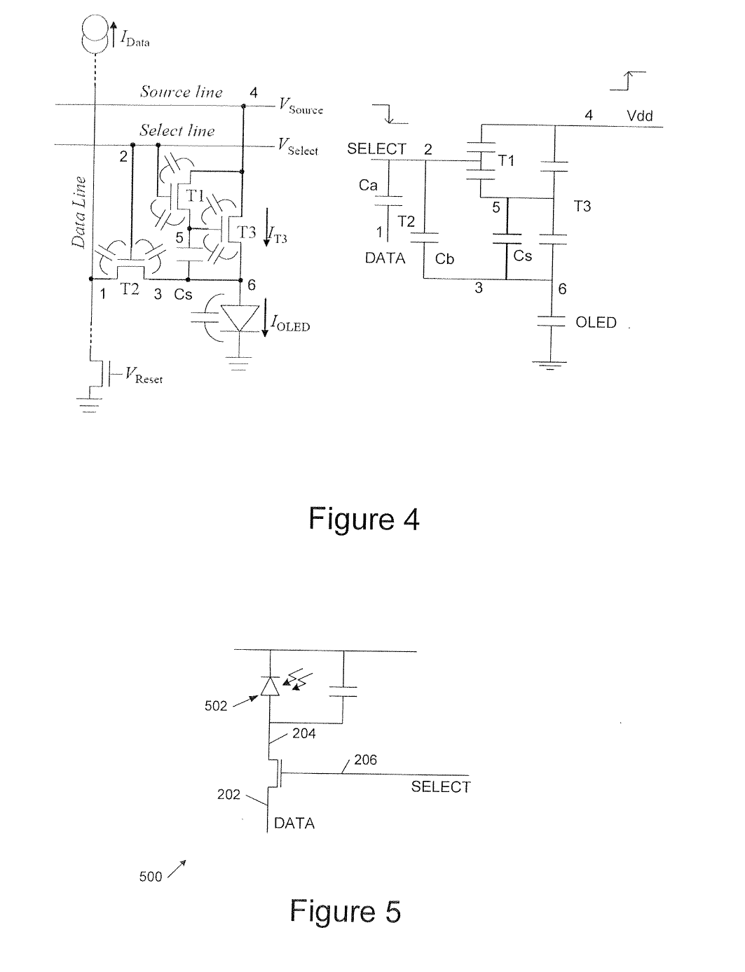

Referring now to FIG. 4 this shows the current controlled pixel driver circuit of FIG. 1a with nodes 1-6 labelled, and showing internal, parasitic capacitances of devices T1-T3 and the OLED. The network formed by these capacitances is shown separately on the right hand side of FIG. 4. Other pixel circuits have similar networks of internal device capacitances. In the example of FIG. 4, and referring to FIG. 1b, the V_{DD} line (node 4) rises at substantially the same time as the select line (node 2) falls. This can have the (undesired) effect of changing the voltage across the storage capacitance Cs, which determines the gate-source voltage of the drive transistor T3. One technique to address this problem is to increase the value of the storage capacitor, effectively making the circuit “stiffer”, but this increases the programming time. Instead it may be preferable to adjust the ratio of capacitances in one or more of transistors T1, T2 and T3 to reduce the voltage changes on storage capacitor Cs, and hence achieve more accurate luminance control without substantially compromising programming time. The precise values/ratios of the capacitors shown in the network of FIG. 4 will depend on details of the circuit implementation and may be selected in a routine manner, for example using a computer aided design (CAD) system.

In a voltage programmed circuit achieving a fast programming time may be less of a problem than possible changes in the value of the voltage stored on the pixel data storage capacitor. Again this may be addressed by adjusting the ratios of gate-source/drain: gate-drain/source capacitance in one or more of transistors T1, T2 and T3, for example by employing a CAD system. Referring, say, to the voltage programmed pixel circuit of FIG. 1c, the VDD line (node 4) is fixed but the voltage on the select line (node 2) changes, and again through the network of internal/parasitic capacitances in the devices of the pixel circuit the voltage on the storage capacitor 120 of FIG. 1c may end up being set at a different value to that programmed on the data line.

In embodiments of a pixel circuit it is preferable to employ the above-described techniques to one or more transistors which are operating in a substantially linear mode, that is similar to a resistor, in which case the gate-drain/source overlap effectively functions as a capacitor; in saturation mode more complex behaviour may be observed. In embodiments since the drive transistor driving the OLED is generally a relatively higher power device than the other transistors of the pixel circuit this may be fabricated with a wide, short channel, for example of a serpentine shape, which may provide limited practical scope for introducing an internal gate-source/drain capacitance asymmetry in the device (since in general such a serpentine channel provides a substantially symmetric overlap).

FIG. 5 shows a simple example of a pixel sensor circuit 500 in which like elements to those previously described are indicated by like reference numerals. In the illustrated example the pixel circuit 500 includes an organic photo diode 502.

As the skilled person will understand the above described circuits may be implemented in either n- or p-channel variants. The skilled person will further understand that many other variations are possible and that, for example, one or the more of the circuits illustrated in FIGS. 1c to 1g may also be implemented using a floating gate drive transistor (see, for example, GB 0721567.6 and GB 0723859.5, hereby incorporated by reference. More generally, virtually any pixel circuit described in the art may be configured to incorporate a curved gate (switching) TFT along the lines described above.

No doubt many other effective alternatives will occur to the skilled person. It will be understood that the invention is not limited to the described embodiments and encompasses modifications apparent to those skilled in the art lying within the scope of the claims appended hereto.

1. An active matrix organic light emitting diode (OLED) display, the display having a plurality of OLED pixels each with an associated pixel driver circuit, said display having a plurality of select lines and a plurality of data lines to select a said OLED pixel and to write data for display to a selected said OLED pixel, wherein each said pixel driver circuit is coupled to a said select line and to a said data line, wherein said pixel driver circuit includes a drive transistor configured to drive an OLED and further includes a select transistor having a first terminal coupled to a said select line and a second terminal coupled to a said data line, wherein one of said first and second terminals of said select transistor comprises a gate connection of said select transistor and wherein the other of said first and second terminals of said select transistor comprises one of a drain and a source connection of said select transistor, and wherein said select transistor comprises a transistor with source, drain, and gate regions, wherein said gate region at least partially overlaps said source and drain regions, and wherein an area of said overlap of said gate region with one of said source region and said drain region is greater than an area of said overlap with the other of said source region and said drain region so that a capacitance between said gate connection and one of said drain and source connections is less than a capacitance between said gate connection and the other of said drain and source connections.

2. An active matrix organic light emitting diode (OLED) display as claimed in claim 1 wherein said second terminal comprises said other of said source region and said drain region.

3. An active matrix organic light emitting diode (OLED) display as claimed in claim 1 wherein said one of said source region and said drain region has a pair of arms or projections which at least partially encompasses said other of said source region and said drain region.

4. An active matrix organic light emitting diode (OLED) display as claimed in claim 1 wherein said gate region has a generally arcuate shape.

5. An active matrix organic light emitting diode (OLED) display as claimed in claim 4 wherein, in a lateral plane, said curved gate region curves in a single direction.

6. An active matrix organic light emitting diode (OLED) display as claimed in claim 1 where a capacitance of between said gate region and said one of said source region and said drain region is at least 1.5 times greater than a capacitance between said gate region and said other of said source region and said drain region.

7. An active matrix organic light emitting diode (OLED) display as claimed in claim 1 wherein said select transistor has a third terminal, wherein said third terminal comprises the other of said drain and source connection of said select transistor, and wherein an internal capacitance of said select transistor between said first terminal and said second terminal is less than an internal capacitance of said select transistor between said first and said third terminal.

8. An active matrix organic light emitting diode (OLED) display as claimed in claim 1 wherein said select transistor has a channel width of at least 1 μm, and wherein a maximum lateral dimension of said one of said source region and said drain region is at least 2 μm greater than a maximum lateral dimension of said other of said source region and said drain region.

9. An active matrix organic light emitting diode (OLED) display as claimed in claim 1 wherein said first terminal of said select transistor comprises said gate connection of said select transistor and wherein said second terminal of said select transistor comprises a said drain or source connection of said select transistor.

10. An active matrix organic light emitting diode (OLED) display as claimed in claim 1 wherein said display is a top-emitting display and wherein said select transistor is a bottom gate transistor.

11. An active matrix organic light emitting diode (OLED) display as claimed in claim 1 wherein a said pixel drive circuit further comprises said drive transistor configured to drive an OLED of the associated pixel and at least one further transistor, and wherein said at least one further transistor has a said curved gate region.

12. An active matrix organic light emitting diode (OLED) display as claimed in claim 11 wherein a ratio of an internal gate-source capacitance of said further transistor and an internal gate-drain capacitance of said further transistor is different to substantially 1:1, said ratio differing from 1:1 such that, in operation a voltage swing on said select line has a reduced influence on a pixel luminescence value from said data line stored in said pixel circuit during programming as compared with a said voltage swing for a 1:1 said ratio.

13. An active matrix organic light emitting diode (OLED) display as claimed in claim 1 wherein said pixel driver circuit comprises a voltage controlled pixel driver circuit, and wherein a voltage level on said data line sets a luminance of an OLED driven by said pixel driver circuit.

14. An active matrix organic light emitting diode (OLED) display as claimed in claim 1 wherein said pixel driver circuit comprises a current controlled pixel driver circuit, and wherein a current level on said data line sets a luminance of an OLED driven by said pixel driver circuit.

15. A pixel circuit for an active matrix display, the pixel circuit having a select line to select the pixel, and a data line for reading or writing pixel data from or to the pixel, wherein the pixel driver circuit further comprises a drive transistor configured to be able to drive an optoelectronic light emitting element and further comprises a pixel select transistor having two channel connections and a gate connection, and wherein said gate connection is coupled to one of said data line and said select line, wherein a first of said channel connections is coupled to the other of said data line and said select line, and wherein an internal capacitance of said pixel select transistor between said gate connection and said first of said channel connections is less than internal capacitance of said pixel select transistor between said gate connection and a second of said channel connections.

16. A pixel circuit as claimed in claim 15, wherein said internal capacitance between said gate connection and said first of said channel connections is less than two thirds, preferably less than one half, of said internal capacitance between said gate connection and said second of said channel connections.

17. A pixel circuit as claimed in claim 15 wherein said first channel connection includes a patterned first channel region, wherein said second channel connection includes a patterned second channel region, and wherein said second channel region at least partially wraps around said first channel region.

18. A pixel circuit as claimed in claim 15 wherein said pixel circuit is a pixel driver circuit for driving an organic light emitting diode (OLED), and wherein said pixel data comprises pixel luminance data defining a luminance of said OLED.

19. A pixel circuit as claimed in claim 18 wherein said pixel drive circuit comprises a current controlled pixel driver circuit including a pixel data storage capacitor coupled to said second channel connection, said drive transistor coupled to said pixel data storage capacitor, and a programming transistor to store a charge on said pixel data storage capacitor during programming of said pixel driver circuit by a current on said data line whilst said pixel select transistor is controlled by said select line to couple said data line to said storage capacitor.

20. An active matrix OLED display having a plurality of pixels each with an associated pixel driver circuit as claimed in claim 15.

21. A pixel circuit for an active matrix display, said pixel circuit including at least one field effect transistor (FET) with a curved gate region such that a gate-source capacitance of said FET is different to a gate-drain capacitance of said FET.
